(19) United States
(12) Patent Application Publication
(10) Pub. No.: US 2009/0019510 A1
(43) Pub. Date: Jan. 15, 2009

(54) DEVICE AND METHOD FOR STORING AUDIO/VIDEO DATA IN A HOME NETWORK

(75) Inventor: Nicolas Duflot, Brunoy (FR)

Correspondence Address: AHS INC, 2234 ROAD 181, CHAPPELL, NE, 69129, US

(73) Assignee: KONINKLIJKE PHILIPS ELECTRONIC, N.V., EINDHOVEN (NL)

(21) Appl. No.: 10/596,709

(22) PCT Filed: Dec. 10, 2004
(86) PCT No.: PCT/IB2004/004216

§ 371 Date: Jun. 22, 2006

(30) Foreign Application Priority Data
Dec. 30, 2003 (FR) 0351230

(51) Int. Cl. H04N 7/26; H04N 7/173

(52) U.S. Cl. 725/131; 386/124; 386/E05.001

(57) ABSTRACT

The invention relates to a method and a device for storing audio/video data in a home network. They allow addition of storage possibilities to apparatuses of the set-top box type which do not have or cannot develop them so as to extend the functionality of the apparatus without a software update, dependent on connections/disconnections of peripheral storage equipment. To this end, the invention provides a virtual management of the storage possibilities within one and the same apparatus. An abstraction layer is realized above the physical storage support by software storage means co-operating with control means so as to hide details on the used peripheral storage unit or units from the application. For an application requiring storage of audio/video data, the operation is transparent. The peripheral storage units are detected when they are “hot”, dependent on their connection/disconnection, and are taken into account by the control means at the level of the available storage capacity. The application conducts a dialogue only with a single interface for its storage needs, while the control means co-operate with the software storage means for managing the transfer of data to and from the different peripheral storage units.

The present invention relates to the field of audio/video data transmission within a home network. More particularly, it relates to a device and a method for storing audio/video data in such a network.

With the advent of digital television receivers or set-top boxes incorporating a hard disk (PVR: Personal Video Recorder), the needs for storage are ever increasing. With the technology of hard disks as well as their capacity developing more rapidly than the rate of actual renewal of these apparatuses, it is desirable to foresee their possible stages of development, both in terms of storage capacity and of recording possibility so that, for example, they can be developed to systems which are capable of supporting high-definition digital television. There is no solution in the commercial field at the moment, except that the possibility of changing the hard disk within the apparatus is considered, which has the consequence of annulment of the constructor's guarantee.

American patent US 2002 0,092,021 describes a home network in which the video programs are recorded on a distant peripheral storage unit with the aid of an adequate communication protocol. A major drawback of such a system is that it requires the relevant apparatuses in the network to have knowledge of the communication protocol.

The invention remedies this drawback by proposing a device allowing the development of storage possibilities of a set-top box with the aid of appropriate software architecture.

Such an object is achieved by means of a device according to the invention, referred to as set-top box, comprising:

means for receiving audio/video data transmitted via a communication medium,

at least one application using said received audio/video data and necessitating their storage prior to their use, the application comprising means for issuing requests for storage/retrieval of the received data,

storage means comprising:
means for connection to at least one peripheral storage unit which is capable of physically storing audio/video data,
means for detecting peripheral equipment co-operating with said connection means for detecting the presence of peripheral storage units as from their connection/disconnection to/from the set-top box,
control means co-operating with the detection means for receiving said requests for storage/retrieval of data issued by the application and for controlling the assignment of physical storage addresses in the different peripheral storage units which are present,
software storage means co-operating with said control means for preserving and retrieving the physical addresses of the data stored in the different peripheral storage units.

In this case, storage possibilities are added to apparatuses which do not have or cannot develop these possibilities so as to extend the functionalities of the apparatus without a software update, dependent on the connections/disconnections of the peripheral storage units. To this end, a virtual management of the storage possibilities within one and the same apparatus is provided. An abstraction layer is realized above the physical storage support by software storage means co-operating with control means so as to hide the details on the used peripheral storage unit or units from the application. For the application, the operation is perfectly transparent. The peripheral storage units are detected when they are “hot”, dependent on their connection/disconnection, and are taken into account by the control means at the level of the storage capacity available for the application. This involves a dialogue only with a single interface for its storage needs, while the control means co-operate with the software storage means for managing the transfer of data to and from the different peripheral storage units.

A second aspect of the invention relates to the storage strategy, i.e. the manner of optimizing the physical storage of the data in the different peripheral units as a function of certain criteria predefined by the user or by the application itself. To this end, a device as described above is provided, wherein the control means comprise interface means with the application for receiving and interpreting the storage/retrieval requests in terms of repartitioning the data stored in the different peripheral units as a function of predetermined storage criteria. These criteria may be related to the rate at which the audio/video data must be stored/retrieved or to the redundancy of the data. Indeed, with applications which are increasingly multimedia-oriented, the required rate may be very important. In contrast, for sensitive data, one could duplicate the information on separate supports so as to have the content always available, even if one of the two supports is damaged.

These and other aspects of the invention are apparent from and will be elucidated, by way of non-limitative example, with reference to the embodiment(s) described hereinafter.

In the drawings:

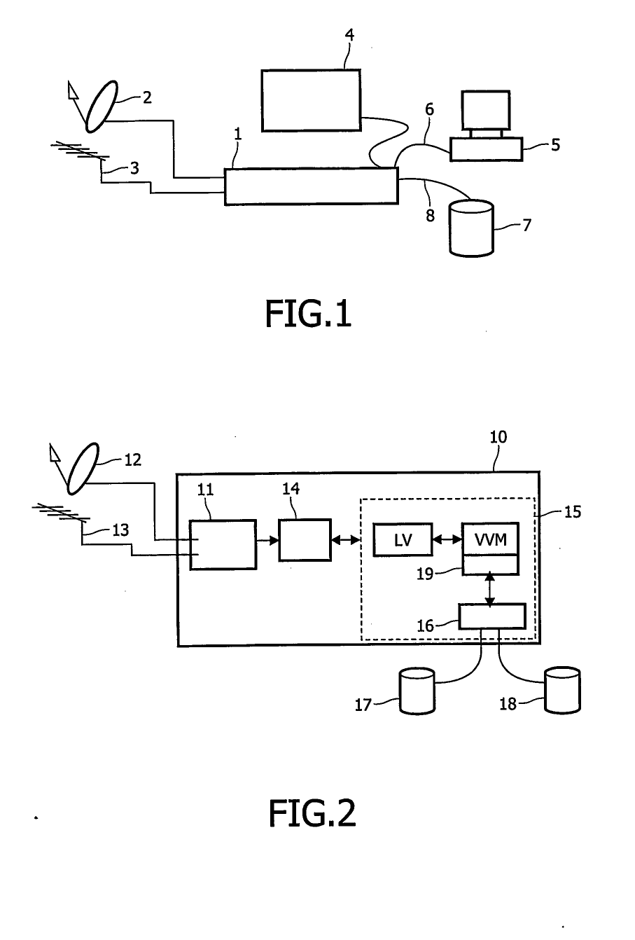

FIG. 1 is a functional diagram showing an example of application of the invention,

FIG. 2 is a functional block diagram illustrating a device according to the invention,

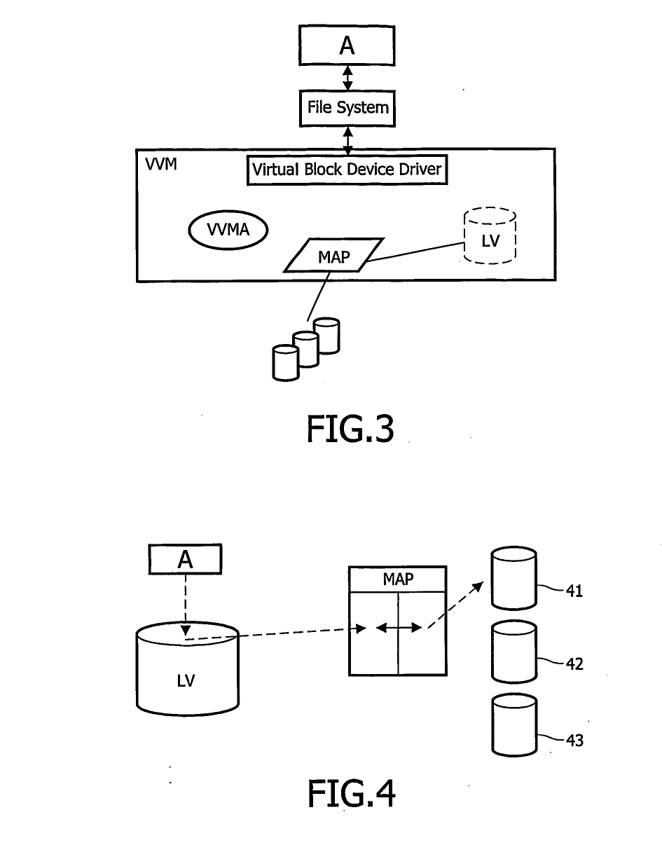

FIG. 3 is a functional block diagram illustrating an embodiment of the device shown in FIG. 2,

FIG. 4 is a functional block diagram illustrating, in greater detail, a mapping table of addresses in accordance with an embodiment of the device of the invention,

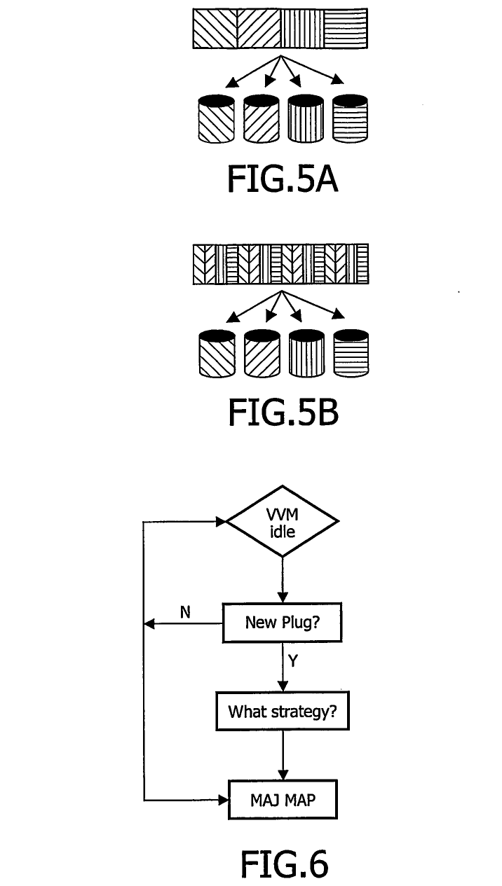

FIGS. 5A and 5B are functional diagrams illustrating two embodiments of the invention, relating to the strategy of storing audio/video data,

FIG. 6 is a flow chart illustrating an example of the storage method according to the invention.

FIG. 1 illustrates an example of a home network according to the invention. It comprises:

a digital device or decoder 1, referred to as set-top box, for receiving and processing audio/video signals transmitted by satellite 2 or by terrestrial digital means 3,

a display screen 4,

a computer 5 connected to the set-top box 1, for example, via an Ethernet connection 6, and

an external hard disk 7 connected to the set-top box 1 by means of a specific connection 8, particularly of the USB, IEEE1394, SAT type, etc.

The expression audio/video is herein understood to mean audio data, video data or both. In the example shown in FIG. 1, it is assumed that the set-top box 1 does not have an internal hard disk or that it is full and can no longer record new data without erasing data already recorded. To remedy this drawback in a simple and effective manner, the invention provides means for virtually managing possibilities of storing the network within the set-top box so as to allow use of these external storage possibilities as an internal hard disk, notably the possibilities of storage of the external hard disk 7 which may be added when they are “hot” in the course of the application, or those of the distant computer 5.

FIG. 2 illustrates diagrammatically the functionalities of the decoder 1 of FIG. 1 for realizing the invention. These functionalities are shown in the functional block 10 which comprises:

reception means 11 of the conventional type for receiving audio/video data transmitted via one of the available communication media, notably satellite 12 or terrestrial 13,

at least an application 14 using the received audio/video data and requiring them to be stored prior to their use, the application comprising means for issuing requests for storing/retrieving the received data, which requests may be of the conventional type of access to a hard disk,

virtual storage means 15 comprising:
connection means 16 (notably of the USB, IEEE1394, SAT type, etc.) to two peripheral storage units 17 and 18 notably from an external hard disk and a PC as in the example shown in FIG. 1, capable of physically storing the received audio/video data,
peripheral detection means 19 co-operating with said connection means for detecting the presence of peripheral storage units as from their connection/disconnection to/from the set-top box,
virtual storage control means VVM (Virtual Volume Manager) co-operating with the detection means for receiving the requests for storage/retrieval of the data transmitted by the application and for controlling the assignment of physical storage addresses in the different peripheral storage units which are present,
software storage means LV (logic volume+mapping table) co-operating with said control means VVM for preserving and retrieving the physical addresses of the data stored in the different peripheral storage units.

The connection means 16 as well as the peripheral detection means 19 may use different known techniques which themselves do not form part of the invention. The control means VVM co-operate with the software means LV for realizing the storage of data required for the application. As for the application itself, it uses the virtual support represented by the software storage means LV piloted by the control means VVM which hide the details at the location where the data are stored, i.e. the (peripheral) physical support or supports used, represented by the cylinders 17 and 18 in FIG. 2, as well as the location of the data on the support itself. The interest of thus separating the software from the hardware in order that the application only conducts a dialogue with the virtual storage means is to be able to intervene on the physical support, notably to replace it, to extend it for adding functionalities to it or to increase its performance without the software being warned and even during the execution of the application, i.e. in a completely transparent manner.

FIG. 3 shows in more detail an example of implementing the virtual storage means in a set-top box according to the invention. In accordance with a preferred embodiment of the invention, the software storage means LV co-operate with a mapping table, MAP, comprising the virtual addresses of the data to be stored so as to assign a physical storage address to them, which corresponds to a memory space reserved in one of the peripheral storage units, represented by cylinders in FIG. 3. An agent for the control means, the VVM Agent, denoted VVMA is intended to update this table dependent on the storage/retrieval requests by the application A. The application A may be of different types. It may be an application for storing video, playing and filing pieces of music (notably in the MP3 format) or simply visualizing images (notably in the JPEG or MPEG format) recorded on the different available storage means. The application A conducts a dialogue with a filing system, denoted File System, by means of the programming interfaces or APIs (Application Programming Interface) which are file-oriented as in any conventional operating system. These requests to the File System are thus of the conventional type and will not be described in detail. File operations are concerned, such as the operations of the Read, Write, Ilseek, Readdir open type, etc. The File System which receives these requests must translate them for the virtual storage means into conventional block operations such as Open, release, block_read, block_write, etc. These operations are subsequently treated at the level of the virtual storage means by a single interface or virtual storage driver, denoted Virtual Block Device Driver, which has the function of realizing the programming interface or API between the application and the different storage means. For example, small programs for opening/closing the files or controlling the input/output are concerned, as well as for parametrizing and implementing the storage strategy to be used. As far as the latter is concerned, two embodiments will be described with reference to FIGS. 5A and 5B.

FIG. 4 illustrates the functioning of the mapping table MAP. When the application A wants to record data, it “sees” only the software storage means LV, referred to as “logic volume”, by virtue of the installed software architecture. It then proceeds as if it were a conventional storage unit. These are the virtual control means VVM which constitute the correspondence between the location of the data on the logic volume and their real location on the physical peripheral units, denoted 41 to 43. This table is automatically updated when a storage unit is added or withdrawn by the VVM Agent which co-operates with the means for detecting the connection/disconnection of the peripheral storage units.

FIG. 5 illustrates two embodiments of the invention, corresponding to two different possibilities or strategies of storage according to whether one wishes to prefer the performance related to the rate of the data or, in contrast, according to whether one wishes to maximally discharge the central processor. The security of the data which is related to the available storage space is also envisaged in these two examples. A judicious combination between these extreme strategies may also lead to a good compromise between performance and security at the level of the applications. The logic volume LV seen by the application is represented by a rectangular block which is shaded in different manners and points at hard disks represented by equally shaded cylinders. A shading style corresponds to a hard disk. The logic volume virtually stores the application data which are physically recorded on the different disks designated by their shading type, by means of the mapping table MAP and the VVM Agent as described in FIGS. 3 and 4.

FIG. 5A illustrates a first storage strategy which consists of maximally discharging the central unit or CPU (Central Processing Unit). In accordance with this first strategy, the data are stored on the hard disks one after the other, such that when a disk is full, the data are written on the next disk. The data are thus stored on a single disk at a time, which limits the necessary power for storing and retrieving the data but also limits the traffic because the successive data are recorded on one and the same support, except when the support is full, which necessitates waiting for the end of the complete transfer of a data or a packet of data on the disk so as to be able to perform another transfer.

FIG. 5B illustrates a second storage strategy which uses a method of addressing performance-oriented physical disks. In accordance with this strategy, successive data are stored on the four disks in parallel so as to maximally repartition the data on all the available storage spaces and to improve their rate. The clusters, which are the smallest units of space on the logic volume are repartitioned on the different hard disks, as is shown by way of the shading, in order that two contiguous clusters do not belong to the same hard disk. In the example illustrated in FIG. 5B, the application, when demanding data, can send up to four requests at the same time, contrary to the case illustrated in FIG. 5A where the requests are serialized, i.e. the response to the first request must be awaited before the next request can be made. In the case illustrated in FIG. 5B, the performance may thus be improved by four in terms of rate, as compared with the case illustrated in FIG. 5A.

Indeed, with applications which are increasingly multimedia-oriented, the necessary rate increases incessantly. It is thus interesting that the data can be stored simultaneously on several physical supports so that the necessary rate can be divided by the number of physical supports. Adding a new hard disk may thus have the supplementary result, with respect to the simple fact of increasing the storage capacity, that the rate of the transferred data is increased. One can imagine that the performance of a given hard disk integrated in a set-top box, notably its rate, does not allow realization of certain functions requiring high rates such as the recording of high-definition video streams or of making pauses in a program broadcast in real time via satellite or cable. The latter functionality, more commonly referred to as time shifting, requires a high data rate because it necessitates continuous storage of received audio/video data and subsequently reading them at a slight delay, the delay corresponding to the time which has elapsed during the “pause”. By using an adequate storage strategy, such as that illustrated in FIG. 5B, new functionalities may thus be added to the set-top box at less cost.

As far as, in contrast, the sensitive data are concerned, no matter which principal storage strategy is used, the information can be duplicated on different supports so as to always have the contents available, even if one of the physical supports is damaged.

The choice of the strategy or strategies to be employed may be made in a predetermined manner as a function of certain criteria provided by the user, such as the rate or the security of data to be safeguarded or, dynamically, as a function of the application needs. For example, the Virtual Block Device Driver illustrated in FIG. 3 may be put at the disposal of the application via its APIs, while a list of services allows communication with the application with a view to determining a preferred storage method to be used. The hard disks themselves may have certain programmable functionalities which may be used by the VVM in parallel with the object of increasing its storage performance. For example, functionalities of the direct access type to the memory or DMA (Direct Memory Access) may be concerned, or of anticipated reading, better known as read ahead, which both allow an increase of the disk rate.

FIG. 6 illustrates an example of a virtual storage method according to the invention. In the example illustrated in FIG. 6, the set-top box does not have the possibility of data storage. Thus, it does not implement the functionality of local recording of the video program broadcast in real time or by PVR (Personal Video Recorder). By having it connected to an external hard disk, which may be of the USB, IEEE1394 or SATA type, the VVM Agent detects this addition and dynamically passes the size of the virtual hard disk from a capacity of 0 Go to X Go. One can thus imagine that this event wakes up the PVR functionalities which had been dormant until then. Another case which may also be illustrated by FIG. 6 is the one in which the set-top box has already the PVR possibilities, i.e. it has an internal hard disk but it has reached its maximum storage capacity. The user then has several possibilities. He may clean up his videotheque or add a new external storage solution. By virtue of the VVM, the addition of a new hard disk is completely transparent. The PVR application “sees” just an increase of the storage capacity passed from X Go to X+Y Go, Y Go being the capacity of the new hard disk. This addition may become “hot”, i.e. during a recording. Let us take, for example, the case in which the user wants to record a 2-hour film while the available space on his PVR is not more than 1 h 30. By virtue of the VVM, he will not lose the remaining 1 h 30. The reason is that, contrary to applications which see the two physical storage supports independently, the VVM unites them so as to make them available as one whole for the application. By adding a hard disk having a recording capacity of 20 hours in the quality standard, the application understands that it has the equivalent of 21 hours and 30 minutes of available storage.

The flow chart shown in FIG. 6 represents the operation of the VVM Agent. In the idle state (VVM idle) upon the start of the set-top box, this agent is instructed to discover the new peripheral units (New Plug?) and to incorporate them in the virtual storage. In the case where a new peripheral storage unit is connected to the set-top box (Y), it must subsequently implement a predefined storage strategy (What Strategy?). The strategy may be fixed from the start, notably in the case where several applications can store data. One can also imagine a list of services offered by the VVM Agent, allowing the communication between the application and itself for determining the strategy to be used. Once the strategy is defined, the mapping table is updated by the VVM Agent (MAJ MAP) before it returns to the idle state (VVM idle) while waiting for a new connection/disconnection. In the case where no peripheral storage unit is detected, the VVM Agent returns directly to the idle state.

In practice, the invention is used with software means. To this end, a device according to the invention comprises one or several processors and one or several program storage memories, said programs containing instructions for performing the functions described hereinbefore, when they are executed by said processors.

The drawings and their description illustrate the invention without limiting its scope. It will be evident to those skilled in the art that there are other alternatives to the embodiments described, which do not depart from the scope of the invention. In this respect, some remarks will be made hereinafter. There are numerous means for implementing functions with hardware or software means. In this respect, the drawings are very diagrammatic and illustrate only a particular embodiment of the invention. Although the drawings represent the different functions described by different blocks, this does not exclude that a single hardware or software element realizes several functions, nor that one and the same function is realized by an assembly of hardware or software components or both.

Any indication of a reference to a drawing in a claim does not limit the scope of said claim. Use of the verb “comprise” and its conjugations does not exclude the presence of elements or steps other than those stated in a claim. Use of the article “a” or “an” preceding an element or step does not exclude the presence of several elements or steps.

1. A device, referred to as set-top box, comprising:
means for receiving audio/video data transmitted via a communication medium,
at least one application using said received audio/video data and necessitating their storage prior to their use, the application comprising means for issuing requests for storage/retrieval of the received data,
storage means comprising:
means for connection to at least one peripheral storage unit which is capable of physically storing audio/video data,
means for detecting peripheral equipment co-operating with said connection means for detecting the presence of peripheral storage units as from their connection/disconnection to/from the set-top box,
control means co-operating with the detection means for receiving said requests for storage/retrieval of data issued by the application and for controlling the assignment of physical storage addresses in the different peripheral storage units which are present,
software storage means co-operating with said control means for preserving and retrieving the physical addresses of the data stored in the different peripheral storage units.

2. A device as claimed in claim 1, wherein the software storage means comprise a mapping table which is updated by said control means comprising the virtual addresses of the data to be stored for assigning a physical storage address to them, corresponding to a memory space reserved in a peripheral storage unit.

3. A device as claimed in claim 1, wherein the control means comprise a manager for updating said software storage means as a function of the requests for storage/retrieval of the data and of the peripheral storage units which are present or are detected at the instant of the requests.

4. A device as claimed in claim 1, wherein the control means comprise interface means with the application for receiving and interpreting the storage/retrieval requests in terms of repartitioning the data stored in the different peripheral units as a function of predetermined storage criteria.

5. A device as claimed in claim 4, wherein at least one predetermined criterion is related to the rate at which the audio/video data must be stored/retrieved.

6. A device as claimed in claim 4, wherein at least one predetermined criterion is related to the security of the stored audio/video data.

7. A device as claimed in claim 1, wherein the control means comprise interface means with the application for receiving and interpreting the storage/retrieval requests in terms of repartitioning the data stored in the different peripheral units as a function of application needs.

8. A device as claimed in claim 7, wherein the interface means comprise a list of services allowing communication with the application with a view to determining a preferred storage method to be used for said application.

9. A device, referred to as set-top box, comprising:
means for receiving audio/video data transmitted via a communication medium,
at least one application using said received audio/video data and necessitating their storage prior to their use, the application comprising means for issuing requests for storage/retrieval of the received data,
means for connection to at least one peripheral storage unit which is capable of physically storing audio/video data.

10. A storage method comprising the steps of:
detecting peripheral equipment for detecting the presence of peripheral storage units as from their connection/disconnection to/from a set-top box,
receiving a request for storage/retrieval of audio/video data issued by an application using said audio/video data and necessitating their storage prior to their use,
controlling the assignment of physical storage addresses in the different peripheral storage units that are detected, and
software storage for preserving and retrieving the physical addresses of the data stored in the different peripheral storage units.
